(19) United States
(12) Patent Application Publication
(10) Pub. No.: US 2013/0032538 A1
(43) Pub. Date: Feb. 7, 2013

(54) SYSTEMS AND METHODS FOR FORWARD OSMOSIS FLUID PURIFICATION

(71) Applicant: Subramanian Iyer, Yorba Linda, CA (US)

(72) Inventor: Subramanian Iyer, Yorba Linda, CA (US)

(73) Assignee: NRGTEK, INC, Orange, CA (US)

(21) Appl. No.: 13/563,735

(22) Filed: Aug. 1, 2012

Related U.S. Application Data
(60) Provisional application No. 61/513,808, filed on Aug. 1, 2011.

(51) Int. Cl. B01D 61/00; C02F 1/44

(52) U.S. Cl. 210/648

(57) ABSTRACT

A method of purifying high temperature water utilizing forward osmosis is described comprising exposing the fluid to a semi-permeable membrane comprising a material capable of functioning effectively at 70-85° C., the membrane comprising a feed-solution-facing surface and a draw-solution-facing surface; directing a draw solution comprising at least one organic liquid solute and a solvent to the draw-solution-facing surface of the semi-permeable membrane, such that a quantity of the fluid is drawn by osmotic pressure across the semi-permeable membrane into the draw solution, leading to said fluid having a higher concentration of dissolved solids than prior to exposure to the semi-permeable membrane, and leading to the draw solution being more diluted than prior to being directed to the semi-permeable membrane; and boiling the draw solution so as to separate the organic liquid solute from the fluid drawn across the semi-permeable membrane for recirculation of the organic liquid solute.

### RELATED APPLICATION

This application is based on and claims priority to U.S. Provisional Application Ser. No. 61/513,808, filed on Aug. 1, 2011, the entire contents of all of which is hereby expressly incorporated by reference.

### BACKGROUND

The embodiments herein relate generally to the purification of fluids and more specifically to the desalination and purification of produced water streams from oil and gas fields.

Desalination and purification of produced water for steam production is a major need for the oil industry, especially when dealing with heavy oils or high-viscosity oils. Produced water from oil and gas fields needs to be desalinated and purified before it can be used for steam production for re-injection purposes to increase oil flow rates to the surface. Typically, the water for steam generation needs to contain a Total Dissolved Solids (TDS) level of below 8,000, especially if the TDS is comprised of salts of various mono-valent or multi-valent ions. The use of higher TDS levels results in boiling point elevation of the water, as well as extensive corrosion of the boiler elements, or extensive scaling inside the boiler elements, leading to lower heat transfer and reduced energy efficiency. The costs of desalination and purification of the produced water is a significant expense in the operation of oil production from heavy-oil wells.

Desalination using membrane processes, which mainly rely upon reverse osmosis (RO), are presently a major method for clean-up of the produced water. Reverse osmosis uses hydraulic pressure to overcome the osmotic pressure of salt solutions, allowing water-selective permeation of salt-free water to migrate from the saline side of a membrane to the freshwater side. However, RO systems need high pressures (50 to 100 atm or 800 to 1500 psi) and extensive pre-treatment of seawater to allow sufficient permeation through the RO membrane, leading to a produced water conversion rate between about 35 to 70%, based on the TDS and quality of the initial produced water.

Consequently, a need remains for water purification processes that can operate with lower energy requirements, higher efficiency, and/or lower costs than the current state-of-the-art fluid purification processes for steam generation for heavy-oil wells.

### SUMMARY

In embodiments of the present invention, a method of purifying a fluid utilizing forward osmosis are provided, with one exemplary method comprising exposing the fluid to a semi-permeable membrane comprising a material capable of functioning effectively at 70-85° C., the membrane comprising a feed-solution-facing surface and a draw-solution-facing surface; directing a draw solution comprising at least one organic liquid solute and a solvent to the draw-solution-facing surface of the semi-permeable membrane, such that a quantity of the fluid is drawn by osmotic pressure across the semi-permeable membrane into the draw solution, leading to said fluid having a higher concentration of dissolved solids than prior to exposure to the semi-permeable membrane, and leading to the draw solution being more diluted than prior to being directed to the semi-permeable membrane; and boiling the draw solution so as to separate the organic liquid solute from the fluid drawn across the semi-permeable membrane for recirculation of the organic liquid solute. Such a method has advantageous applicability in the oil and gas sector where super-heated pressurized steam is used in the extraction process, and for which purification of the steam is important for recirculation of the steam.

### BRIEF DESCRIPTION OF THE FIGURES

The detailed description of some embodiments of the invention will be is made below with reference to the accompanying figures, wherein like numerals represent corresponding parts of the figures.

FIG. 1 shows a schematic of one embodiment of a prior art forward osmosis system, as discussed in greater detail in U.S. Pat. No. 8,021,553, issued on Sep. 20, 2011;

FIG. 2 shows a schematic of one embodiment of a prior art reverse osmosis system presently utilized in an industrial water recovery system used for oil and gas production;

FIG. 3 shows a schematic of one embodiment of the present invention forward osmosis system for use in water recovery system, including such systems employed for oil and gas production.

### DETAILED DESCRIPTION OF CERTAIN EMBODIMENTS

The systems and methods disclosed herein utilize forward osmosis for fluid purification, such as produced water desalination and/or purification for steam production. Various embodiments include the realization that the function of forward osmosis can be improved through the use of one or more organic solutes to generate high osmotic pressure differentials with the produced water or fluid to be treated. The use of organic and/or cloud point solutes can advantageously permit recycling of the forward osmosis permeate through boiling or cloud-point extraction. The result is systems and methods that can operate with lower energy requirements, lower operating temperatures and pressures, higher efficiency, high flux rates of fluids, and/or lower costs than previous fluid purification processes such as reverse osmosis.

In certain embodiments, forward osmosis systems and methods are disclosed comprising a closed processing loop employing, for example, organic solutes for purification of produced water. The systems and methods take produced water input and discharge purified water for steam generation. The solutes that drive forward osmosis of water from the salt water are recovered through either cloud point precipitation and filtration, for cloud point solutes, or for those organic solutes that do not cloud, the water is distilled out and the organic solutes reused in future processing. Alternatively, even cloud-point solutes can be recovered by distilling the water out for steam generation.

In various embodiments, forward osmosis fluid purification systems are provided. A system can comprise a semi-permeable membrane having a feed solution-facing surface opposite a draw solution-facing surface. A system can comprise a feed solution in communication with the feed solution-facing surface of the semi-permeable membrane, wherein the feed solution comprises a fluid to be purified and impurities dissolved in the fluid to be purified. The system can comprise a draw solution in communication with the draw solution-facing surface of the semi-permeable membrane.

The system can comprise a precipitation system configured to precipitate at least one cloud point solute from the draw solution. Alternatively, use of organic solutes that either cloud at high temperatures or do not cloud at all can also be used for steam generation, especially if the organic solutes are liquid at the temperatures of operation in the forward osmosis loop or during steam generation.

A forward osmosis fluid purification system can comprise a feed solution chamber and a feed solution disposed in the feed solution chamber comprising a fluid and impurities dissolved in the fluid. A system can comprise a draw solution chamber and a draw solution disposed in the draw solution chamber comprising the fluids and at least one cloud point solute dissolved in the fluid. A system can comprise a semi-permeable membrane disposed between the feed solution chamber and the draw solution chamber separating the feed solution from the draw solution, wherein the membrane is configured to permit diffusion of the fluid from the feed solution into the draw solution. A system can comprise a precipitation system in communication with the draw solution chamber, wherein the precipitation system is configured to cause precipitation of at least one cloud point solute in the draw solution. A system can comprise a filtration system in communication with the precipitation system configured to separate at least a portion of the precipitate at least one cloud point solute from the fluid in the draw solution. A system can comprise a return line in communication with the filtration system configured to receive the separated at least one cloud point solute and return the at least one cloud point solute to the draw solution chamber. A system can comprise a return loop from the steam production unit to return the organic solute, after removal of water as steam, back to the draw solution in the forward osmosis operation. A system can comprise an outlet line in communication with the filtration system configured to receive the fluid separated from the draw solution.

The draw solution can comprise at least one organic solute, including a cloud point solute. The concentration of the solute in the draw solution can be greater than the concentration of the impurities in the feed solution. The feed solution can comprise produced water. The fluid to be purified can be water. The solubility of the at least one cloud point or organic solute in the fluid to be purified can be a molar ratio of at least 3:1. The at least one cloud point or organic solute can have a molecular weight between about 300 Da and 8000 Da. The at least one cloud point or organic solute can comprise a hydrophobic component and a hydrophilic component. The at least one cloud point or organic solute can comprise a polyoxyorganic chain. The at least one cloud point solute can comprise a polyethylene glycol or a polypropylene glycol. The at least one organic solute can comprise an ethoxylate or a glycol. The at least one cloud point solute comprises a fatty acid ethoxylate or a fatty alcohol ethoxylate, or a co-block polymer comprised of ethoxylates, propoxylates and butoxylates. The concentration of the at least one cloud point or organic solute in the draw solution can be between about 30% and 95%. The concentration of the at least one cloud point or organic solute in the draw solution can be between about 50% and 90%.

The precipitation system can comprise a heater configured to heat the draw solution to at least the cloud point temperature of the draw solution or to the temperature needed for steam generation, thus separating water from the organic solute. The precipitation system can comprise a gas treatment system configured to add at least one water-insoluble gas to the draw solution to lower the cloud point of the draw solution.

The system can comprise a filtration system configured to remove the precipitated at least one cloud point solute from the fluid to be purified in the draw solution. The filtration system can comprise a nanofiltration membrane or an ultrafiltration membrane. The system can comprise a redissolution system configured to redissolve the precipitated cloud point solutes to form a recycled draw solution.

In various embodiments, methods for purifying fluids are provided. A method can comprise disposing a feed solution and a draw solution opposite a semi-permeable membrane. The feed solution can comprise a fluid to be purified and impurities dissolved in the fluid to be purified. The draw solution can comprise at least one cloud point solute. The concentration of the at least one cloud point solute in the draw solution can be greater than the initial concentration of the impurities in the feed solution. The method can comprise allowing a quantity of the fluid to be purified to diffuse from the feed solution, through the semi-permeable membrane, and into the draw solution through forward osmosis. The method can comprise precipitating the cloud point solutes from the fluid to be purified in the draw solution. The method can comprise treating the draw solution to cause precipitation of the cloud point solutes or boiling out the water in order to re-concentrate the draw solution for re-use. The method can comprise passing the draw solution through a filtration system to separate at least a portion of the precipitated at least one cloud point solute from the fluid to be purified. The method can comprise returning the separated at least one cloud point solute to the draw solution opposite the semi-permeable membrane.

In one embodiment, a method of purifying a fluid containing dissolved solids utilizing forward osmosis comprises exposing the fluid to a first surface of a semi-permeable membrane comprising a feed-solution-facing surface and a draw-solution-facing surface, the first surface comprising the feed-solution-facing surface; directing a draw solution comprising at least one organic liquid solute and a solvent to the draw-solution-facing surface of the semi-permeable membrane, such that a quantity of the fluid is drawn by osmotic pressure across the semi-permeable membrane into the draw solution, leading to said fluid having a higher concentration of dissolved solids than prior to exposure to the semi-permeable membrane, and leading to the draw solution being more diluted than prior to being directed the semi-permeable membrane; and boiling the draw solution so as to separate the organic liquid solute from the fluid drawn across the semi-permeable membrane for recirculation of the organic liquid solute. The method may further comprise recirculating the organic liquid solute for use as additional draw solution. The method may further comprise directing the fluid separated from the liquid organic solute after boiling for use in the extraction of fossil fuels. The fluid to be purified may be water. The organic solute may comprise a polyoxyorganic chain, or a polyethylene glycol or a polypropylene glycol, or a fatty acid or fatty alcohol ethoxylate. Other similar nature organics are contemplated as well.

The feed solution can comprise produced water. The fluid to be purified can be water. Precipitating the cloud point solutes can comprise adding at least one water-insoluble gas to lower the cloud point of the draw solution. Precipitating the cloud point solutes can comprise adding at least a water-soluble salt to lower the cloud point of the draw solution. Precipitating the cloud point solutes can comprise heating the draw solution to at least the cloud point of the draw solution.

The method can comprise removing the precipitated cloud point solutes from the draw solution. Removing the precipitated cloud point solutes can comprise filtering the draw solution through a nanofiltration membrane. The method can comprise redissolving the precipitated cloud point solutes to form a recycled draw solution. Redissolving the precipitated cloud point solutes can comprise flushing the nanofiltration membrane at a temperature below the cloud point temperature of the cloud point solutes.

In various embodiments, assemblies for forward osmosis systems to be used for steam generation are provided. An assembly can comprise a high-temperature semi-permeable membrane having a feed solution-facing surface opposite a draw solution-facing surface. The assembly can comprise a feed solution input in communication with the feed solution-facing surface of the high-temperature semi-permeable membrane, wherein the feed solution input is configured to supply a feed solution comprising a fluid to be purified and impurities dissolved in the fluid. The assembly can comprise a draw solution preparation in communication with the draw solution-facing surface of the semi-permeable membrane, wherein the draw solution preparation comprises at least one cloud point solute.

In various embodiments, the draw solute can be an organic polymer, comprising concentrated solutions of polyethylene glycols with various molecular weights, to draw fresh water out of produced water across a semi-permeable membrane, thereby becoming dilute solutions of polyethylene glycols, which are subsequently purified and separated from the diluted water by converting the water to steam, for recycling of the now-concentrated draw solute back to the forward osmosis process, and the steam injected into oil wells for production of oil.

In various embodiments, processes for purification of solvents are provided. A process can comprise inducing forward osmosis across a semi-permeable membrane by creating an osmotic pressure differential using a draw solution comprising one or more solutes having a cloud point below the boiling point of the solvent, whereby the draw solution becomes more diluted as solvent is drawn across the membrane. The process can comprise heating the diluted draw solution to just above the cloud point temperature to trigger phase separation of the solute, or alternatively be fed to a boiler system for production of steam and regeneration of the concentrated solute. The process can comprise separating the solutes from the draw solution by filtration. The process can comprise retrieving the solutes for recyleable use in the forward osmosis process.

At least one of the solutes can comprise an organic compound characterized by a high osmotic pressure. At least one of the solutes can comprise a polymeric compound characterized by a high osmotic pressure. The solute can comprise a molecular weight of about 300 to 8,000.

In various embodiments, processes for desalination of salinated water are provided. A process can comprise osmotically separating pure water from salinated water by inducing forward osmosis through a semi-permeable membrane by creating an osmotic pressure differential across the membrane using concentrated solutions of solutes in water to create a solution with higher osmotic pressure than the desalinated water. The osmotic separation can serve to drive pure water across the membrane from the salinated water side to the side containing the solutes by virtue of the high solubility and high osmotic pressures in the solvent of the solutes being used. The osmotic separation through forward osmosis can result in a diluted solution. The process can comprise inducing clouding of the diluted solution of solutes by heating the solution to above the cloud point of the solutes by reaching a temperature at which a solubility inversion of the solute in the solvent occurs, thereby reducing its solubility and causing it to precipitate out of the solution. The process can comprise distillation of the diluted solution by heating the solution to the boiling point of water thereby removing the water and re-concentrating the draw solution for re-use. The process can comprise separating potable water as a permeate from the organic solutes by a mechanism of filtration. The process can comprise re-dissolving the clouded solutes filtered out from the water by reverse flushing the filtration system at a temperature below the cloud point of the solutes and generating a solution of concentrated organic solutes in water for recycling for use in forward osmosis processing.

At least some of the solutes can comprise organic solutes. At least some of the solutes can comprise polymeric solutes. At least some of the organic solutes can have a cloud point well below the boiling point of water in the temperature range of about 35-90° C.

Inducing clouding can be achieved by the addition of water-insoluble gases or water-soluble salts in order to lower the cloud point of the solution to ambient temperatures or thereabout. At least some of the solutes can have a molecular weight of between about 300-8,000 Daltons. The solutes can comprise a hydrophobic component and a hydrophilic component to generate sufficiently high osmotic pressures to drive water across a semi-permeable membrane by the process of forward osmosis. The solutes can have a high solubility in the solvent greater than 3 molar ratios to generate sufficiently high osmotic pressures to drive water across a semi-permeable membrane by the process of forward osmosis.

In various embodiments, systems for purification of a solvent are provided. A system can comprise a forward osmosis apparatus comprising a semi-permeable membrane, the apparatus configured to permit the creation of an osmotic pressure differential across the membrane using a draw solution comprising one or more solutes having a cloud point substantially below the boiling point of the solvent, whereby the draw solution becomes more diluted as solvent is drawn across the membrane. The system can comprise a mechanism for inducing clouding of the solutes in the draw solution after becoming diluted in the forward osmosis apparatus. The system can comprise a mechanism for distillation of the diluted draw solution. The system can comprise a filtration mechanism for separating the solutes from the solvent in a manner such that the solutes may be recovered for recycling in the forward osmosis apparatus.

For purposes of summarizing the embodiments and the advantages achieved over the prior art, certain items and advantages are described herein. Of course, it is to be understood that not necessarily all such items or advantages may be achieved in accordance with any particular embodiment. Thus, for example, those skilled in the art will recognize that the inventions may be embodied or carried out in a manner that achieves or optimizes one advantage or group of advantages as taught or suggested herein without necessarily achieving other advantages as may be taught or suggested herein.

Preferred embodiments comprise at least one forward osmosis membrane. For the purposes of steam generation, and recycling of the hot solute back to the forward osmosis system, one embodiment comprises the use of high-temperature forward osmosis membranes, capable of operation at high temperatures, in excess of the temperatures of operation of commercial forward osmosis or reverse osmosis membranes made from cellulose triacetate or thin-film composites. It is desirable that such a membrane retain its structural strength, permeability, and resistance to fouling while operating at high temperatures. One embodiment comprises a block copolymer membrane comprising hard and soft polymer blocks, that synergistically combine to give the membrane resistance to high temperatures, and simultaneously allow water passage at the same rate even at the relatively high temperatures.

The driving force for purification of the fluid is the difference in concentrations (that is, the difference in osmotic pressures or the “osmotic pressure gradient”) across the semi-permeable membrane. Osmosis is the diffusion of a solvent through a semi-permeable membrane, from a solution of lower solute concentration (hypotonic solution) to a solution with higher solute concentration (hypertonic solution). Because osmotic pressure is a colligative property, osmosis generally depends on solute concentration, but not on solute identity. Thus, forward osmosis of a solvent fluid will proceed across a semi-permeable membrane so long as the concentration of one solute is greater than the concentration of another solute, regardless of the identities of the solutes.

As the fluid to be purified flows across the semi-permeable membrane and into the draw solution, the feed solution becomes more concentrated over time. When it reaches a certain concentration, the feed solution can be directed through a first conduit for further processing or for return to the environment (e.g., as brine). As an example, a 3.5% NaCl seawater solution can be concentrated to a 10-15% brine solution, prior to discharge back to the ocean. Of course, other concentrations levels are suitable for deciding when to remove the concentrated feed solution. In certain embodiments, continuous removal of the feed solution is contemplated.

Conversely, the draw solution becomes more diluted over time. The diluted draw solution (or “permeate”) comprising water and one or more cloud point solutes can be directed through a second conduit for further processing. In certain embodiments, the diluted draw solution is removed for processing when it reaches a solute concentration of between about 1 and 25%, preferably 10% or less, more preferably about 5% or less, and most preferably about 1%. In certain embodiments, continuous removal of the draw solution is contemplated.

In certain embodiments, the precipitation system comprises a heating unit. In the heating unit (or in the draw solution reservoir), the temperature of the draw solution outflow (or draw solution) is raised until the cloud point is reached and, preferably, slightly exceeded. For example, the draw solution outflow can be raised until the temperature exceeds the cloud point by about 2-5° C. When the cloud point is reached, the cloud point solute begins to form a cloudy precipitate, due to lowered solubility in the fluid to be purified (that is, the solvent). In certain embodiments, a phase separation of the draw solution or draw solution outflow can be observed. For example, the draw solution outflow may separate into two immiscible layers, a solvent layer and a clouded solute layer.

In certain embodiments, the precipitation system comprises a gas treatment unit. In the gas treatment unit (or in the draw solution reservoir), clouding of the draw solution outflow (or draw solution) is achieved by the addition of at least one water-insoluble gas in order to lower the cloud point of the solution to ambient temperatures or thereabout. For example, methyl chloride can be bubbled through the draw solution outflow. In certain embodiments, the precipitation system can comprise a gas treatment unit for lowering the cloud point of the solution and a heating unit for raising the temperature of the draw solution or draw solution outflow. Other techniques for precipitating a cloud point solute from solution are also suitable. In certain embodiments, the draw solute can be regenerated by heating the diluted draw solution to the boiling point of water, whereby the water separates out as steam, leaving the organic draw solute behind for recycling to the forward osmosis process.

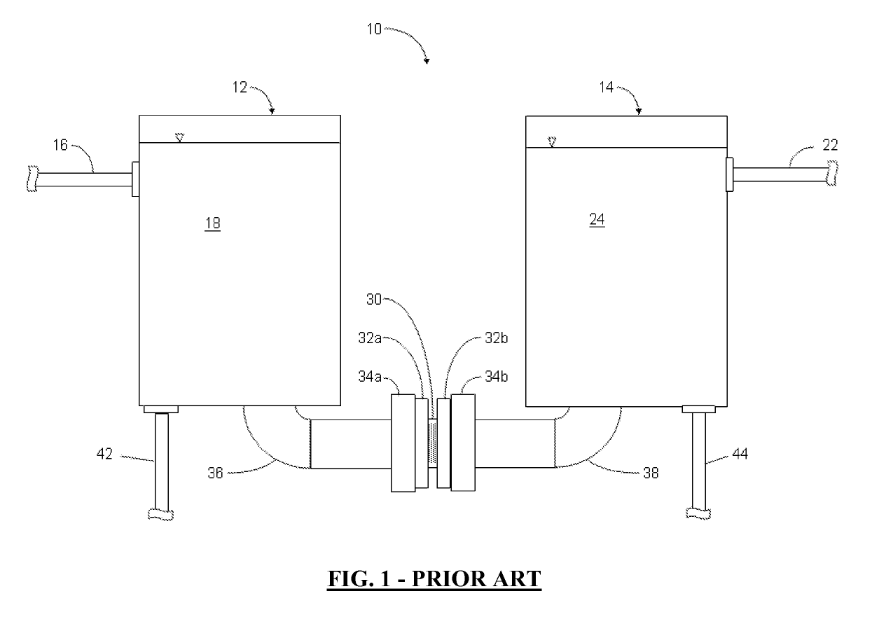

Referring to FIG. 1, a schematic of a prior art forward osmosis system 10 is shown comprising a semi-permeable membrane 30 positioned between a fluid 18 having a content of impurities and a draw solution 24 that can be used to draw, for example, water from the fluid. Additional aspects of this and related systems are described further in U.S. Pat. No. 8,021,553, issued on Sep. 20, 2011, and incorporated herein in its entirety by reference.

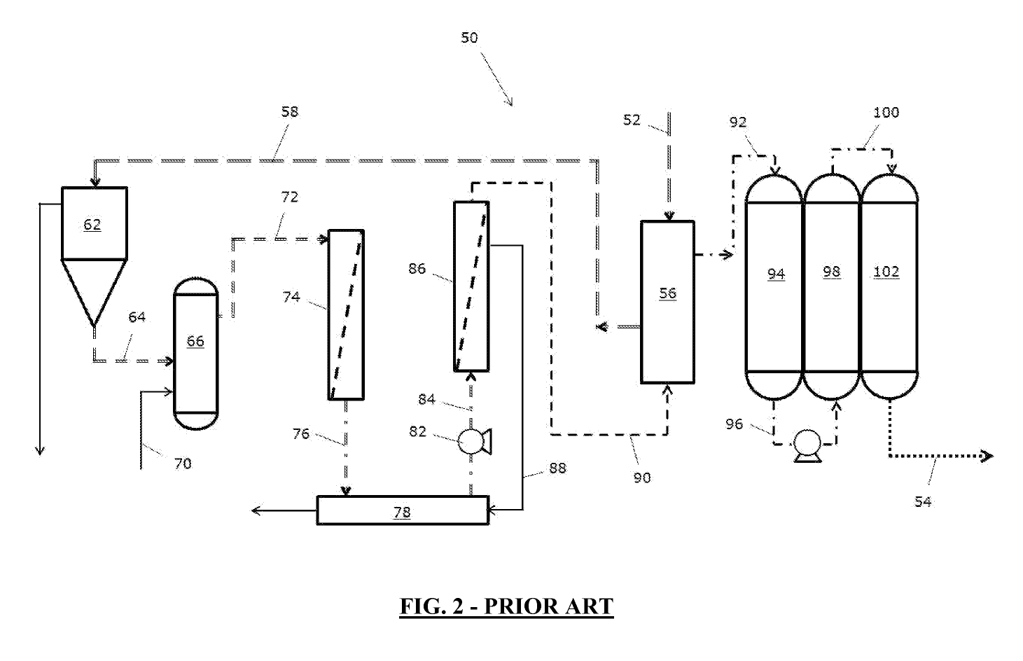

With reference to FIG. 2, one embodiment of an existing water purification system 50 employing reverse osmosis is used in the purifying of steam used in the extraction of oil and gas from the ground. Specifically, the system 50 comprises an influx of brine 52 generated during the extraction of the fossil fuels, where the brine 52 is at an elevated temperature of about 64° C. The water purification system 50 generates an outflux of purified superheated steam 54 having a temperature of about 300° C. and a pressure of about 1300 psi.

In this one example of a prior art RO purification system, the inflow of brine 52 is directed through a heat exchanger 56 that generates a outflow of brine 58 at a reduced temperature of about 50° C. The reduced temperature brine 58 is then directed through a pre-treatment device 62, that may include ultrafiltration, where the treated brine 64 is then directed to an oil separator 66, into which air inoculation 70 is employed. The oil-free brine 72 is then directed through a fine particle filter 74 out of which fairly clean brine 76 flows having yet a further reduced temperature of about 40° C. The brine 76 is directed through an energy recovery device 78 and a pump 82 resulting in a pressurized brine 84 of about 1000 psi and 40° C. The pressurized brine 84 is then directed into a reverse osmosis system 86 where the concentrated high pressure brine retentate 88 is directed through the energy recovery device 78 where pressure energy is exchanged with the incoming treated brine 76 from the particle filter 74.

The permeate 90 from the reverse osmosis system 86 comprises a purified flow of pressurized steam having a temperature of about 40° C., and is then directed into the heat exchanger 56 to be heated by the incoming feed brine 52. The resulting steam outflow 92 from the heat exchanger 56 is then directed into a preheater 94, out of which steam 96 of about 98° C. is then directed into an evaporator 98. The outlet 100 of the evaporator is then directed to a super-heater 102 out of which superheated, purified, pressurized, steam 54 flows for use in extracting fossil fuels.

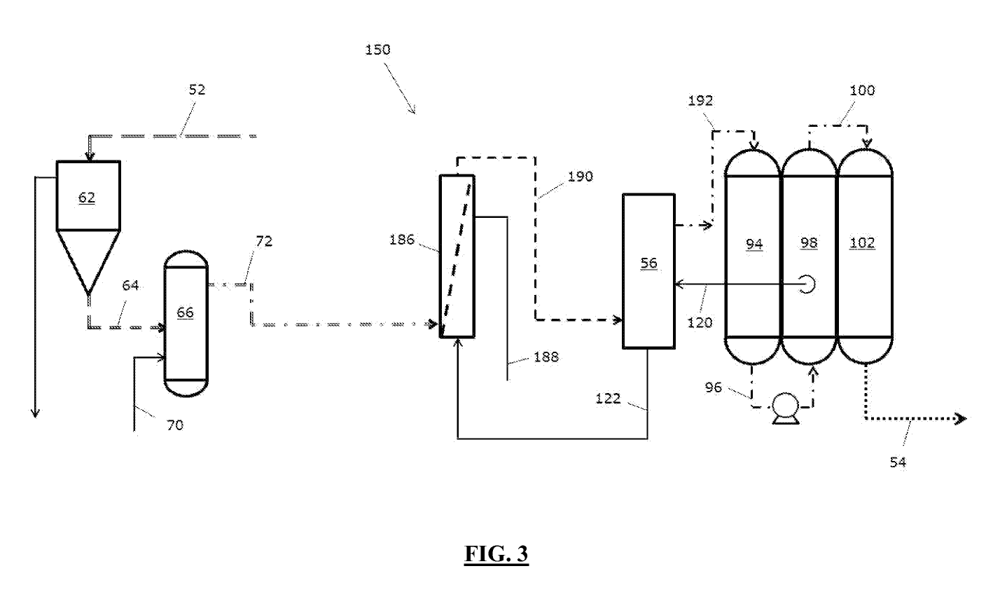

One application of the present invention comprises an FO system such as those described herein to produce purified steam at reduced energy requirements when compared to the prior art. One embodiment of such an application may be described in association with FIG. 3. In that regard, water purification system 150 employs many of the same components of the water purification system 50, but employs a forward osmosis system instead of an RO system. That permits the elimination of the particle filter and the energy recovery device because the FO system is not under pressure. The water purification system 150 also permits direct injection of the feed brine 52 into the pre-treatment device 62 at a temperature of 65° C., without the need to first reduce the temperature using the heat exchanger 56. The treated brine solution 64 is again delivered to the oil separator 66, out of which the oil-free brine 72 may be directed into a forward osmosis system 186 that employs a higher temperature membrane capable of withstanding temperatures in the range of 65° C. The FO system is charged with an organic solution having sufficient osmotic pressure to draw water out of the oil-free brine solution at 65° C.

Having processed the incoming brine 72, the FO system permeate 190 is at an elevated temperature of about 75° C. for reasons explained below, and is directed into the heat exchanger 56, where the purified water 192 is directed into the pre-heater 94, evaporator 98 and super-heater 102, following the same route as the purified steam described in FIG. 2. In this case, however, the heated steam is separated from the organic solute 120 used to draw the water from the brine solution in the FO system. The organic solute is at an elevated temperature of about 98° C. and enters the heat exchanger for purposes of increasing the temperature of the FO system permeate 190, as referenced above. The organic solute 122 is at a reduced temperature of about 80° C. and is directed back into the FO system for use in drawing purified water across the membrane from the brine. The concentrated brine 188 retentate is disposed.

The FO system employing a higher temperature membrane may be employed in other arrangements to retrofit an existing RO system or a new system, and may be used in other applications in which the inflow to the FO system is at a relatively higher temperature. The result is a more energy efficient system over the employment of an RO system for water purification.

What is claimed is:

1. A method of purifying a fluid utilizing forward osmosis, the method comprising:
exposing the fluid to a semi-permeable membrane comprising a material capable of functioning effectively at 70-85° C., the membrane comprising a feed-solution-facing surface and a draw-solution-facing surface;
directing a draw solution comprising at least one organic liquid solute and a solvent to the draw-solution-facing surface of the semi-permeable membrane, such that a quantity of the fluid is drawn by osmotic pressure across the semi-permeable membrane into the draw solution, leading to said fluid having a higher concentration of dissolved solids than prior to exposure to the semi-permeable membrane, and leading to the draw solution being more diluted than prior to being directed to the semi-permeable membrane; and
boiling the draw solution so as to separate the organic liquid solute from the fluid drawn across the semi-permeable membrane for recirculation of the organic liquid solute.

2. The purifying method of claim 1, further comprising re-circulating the organic liquid solute for use as additional draw solution.

3. The purifying method of claim 1, further comprising directing the fluid separated from the liquid organic solute after boiling for use in the extraction of fossil fuels.

4. The purifying method of claim 1, wherein the fluid to be purified is water.

5. The purifying method of claim 1, wherein the organic solute comprises a polyoxyorganic chain.

6. The purifying method of claim 1, wherein at least one organic solute comprises a polyethylene glycol or a polypropylene glycol.

7. The purifying method of claim 1, wherein at least one organic solute comprises an ethoxylate.
